(19) United States
(12) Patent Application Publication
(10) Pub. No.: US 2020/0292344 A1
(43) Pub. Date: Sep. 17, 2020

(54) INFORMATION PROCESSING APPARATUS, INFORMATION PROCESSING METHOD, AND NON-TRANSITORY COMPUTER READABLE STORAGE MEDIUM STORING PROGRAM

(71) Applicant: Toyota Jidosha Kabushiki Kaisha, Toyota-shi (JP)

(72) Inventors: Takashige Hori, Aisai-shi (JP); Makoto Akahane, Nagoya-shi (JP)

(73) Assignee: Toyota Jidosha Kabushiki Kaisha, Toyota-shi (JP)

(21) Appl. No.: 16/789,561

(22) Filed: Feb. 13, 2020

(30) Foreign Application Priority Data
Mar. 11, 2019 (JP) 2019-043329

(51) Int. Cl. G01C 21/34; G06Q 10/10

(52) U.S. Cl. CPC G01C 21/3484; G06Q 10/1095; G01C 21/3492; G01C 21/3438

(57) ABSTRACT

An information processing apparatus includes: a location history acquisition part that acquires history of location information of a terminal used by a user; an estimating part that estimates the user's location for each particular time period in a day based on the history of the location information; a schedule acquisition part that acquires, from the user's schedule information, a scheduled event with a specified destination and start time of the event; a determining part that determines a starting point of the user by referring to the specified start time of the event and the user's estimated location for each particular time period in a day; a searching part that searches for a route to travel from the determined starting point to the specified destination of the event, as well as a necessary time for the route; a calculating part that calculates a departure time for travel to the destination based on the necessary time obtained by the searching part; and an entry part that enters a travel event including the departure time into the user's schedule information.

### CROSS-REFERENCES TO RELATED APPLICATIONS

This application relates to and claims priority from Japanese Patent Application No. JP2019-043329, filed on Mar. 11, 2019, the entire disclosure of which is incorporated herein.

### BACKGROUND

### Field

The present invention relates to an information processing apparatus, an information processing method, and a non-transitory computer-readable storage medium storing a program.

### Description of Related Art

Currently, users can easily manage their schedules by using, among others, smartphones. JP2014-215162 A discloses a schedule management system. In this system, when a user enters his/her schedule data into a database along with a specific destination and starting point, routing is automatically performed based on the entered destination and starting point. Furthermore, the system determines the departure time based on the necessary time that is calculated through the routing, and automatically stores a travel plan including the determined departure time on the database.

### SUMMARY

The technique described in JP2014-215162 A performs routing based on the starting point and destination entered by the user as the schedule data. Thus, if no starting point is input in the schedule data, or if the input starting point is ambiguous, the system is unable to store a travel plan on the database.

In view of the above circumstances, an object of the present invention is to provide a technique for enabling the entry of a travel plan even when schedule data input by a user does not include a starting point.

An information processing apparatus according to an aspect of the present invention includes: a location history acquisition part that acquires history of location information of a terminal used by a user; an estimating part that estimates the user's location for each particular time period in a day based on the history of the location information; a schedule acquisition part that acquires, from the user's schedule information, a scheduled event with a specified destination and start time of the event; a determining part that determines a starting point of the user by referring to the specified start time of the scheduled event and the user's estimated location for each particular time period in a day; a searching part that searches for a route to travel from the determined starting point to the specified destination of the scheduled event, as well as a necessary time for the route; a calculating part that calculates a departure time for travel to the destination based on the necessary time obtained by the searching part; and an entry part that enters a travel event including the departure time into the user's schedule information.

### BRIEF DESCRIPTION OF DRAWINGS

FIG. 1 schematically illustrates a schedule management system according to an embodiment.

FIG. 2 shows an example of the hardware configuration of an information processing apparatus.

FIG. 3 shows an example of the functional block configuration of an information processing apparatus.

FIG. 4A shows an example of a location history database and FIG. 4B shows an example of a schedule database.

FIGS. 5A and 5B show examples of an estimation rule database.

FIG. 6 is a flowchart showing an example of processing steps performed by an information processing apparatus.

FIG. 7 shows specific examples of travel events that are additionally entered by an information processing apparatus.

FIG. 8 shows examples of representations provided by a scheduler on a display of a terminal.

### DETAILED DESCRIPTION

Preferred embodiments of the present invention will now be described with reference to the attached drawings, in which components given the same reference numeral have the same or a similar configuration.

System Configuration

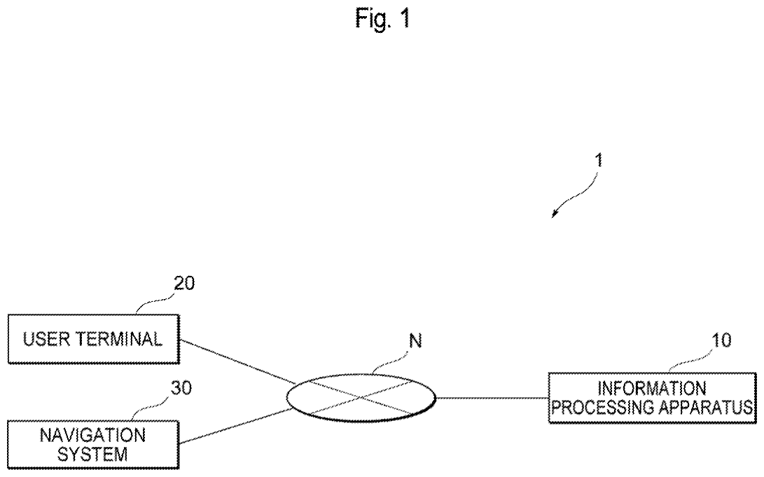

FIG. 1 schematically illustrates a schedule management system according to the present embodiment. The system according to this embodiment includes an information processing apparatus 10 and a terminal 20. Although FIG. 1 shows a single terminal 20, the system may include a plurality of terminals 20. The information processing apparatus 10 and the terminal 20 can communicate with each other via a communication network N.

The information processing apparatus 10 has the functions of: managing scheduled events entered by a user; estimating the user's location and travel means (i.e., a location where the user is likely to stay and a travel means that the user is likely to take), based on the history of location information of the terminal 20; and generating a travel plan (travel program) for implementing a scheduled event entered by the user, by searching for a route by assuming the (estimated) user's location as being the starting point of the route.

The information processing apparatus 10 may comprise one or more servers. For example, the information processing apparatus 10 may comprise a server for managing a user's schedule (a schedule management server); a server for estimating the user's location and travel means (an estimation server); and a server for searching for a route (a routing server). Alternatively, the information processing apparatus 10 may comprise one or more information processing apparatuses including all or part of the above-described functions. Further, the information processing apparatus 10 may comprise a virtual server (e.g., a cloud server).

The terminal 20 is a user's terminal and has the function of obtaining location information and transmitting it to the information processing apparatus 10 or an external server that manages the location information. The terminal 20 may be any type of terminal having the function of obtaining location information, examples of which include a smartphone, a tablet, a mobile phone, a personal computer (PC), a laptop PC, a personal digital assistant (PDA) and a home game machine.

In the present embodiment, the information processing apparatus 10 acquires the history of location information of the terminal 20 and analyzes it so as to estimate the user's location for each particular time period in a day. For example, if the analysis of the history of the user's location information indicates that the user is usually staying at point A (which is the user's home in this example) during night-time, the information processing apparatus 10 determines that the user's estimated location during night-time is point A (the user's home).

The information processing apparatus 10 also estimates the user's travel means by acquiring and analyzing the history of location information of the terminal 20. For example, if the analysis indicates that, on weekdays, the user moves along a train line to travel from point A (the user's home) to the user's workplace, the information processing apparatus 10 estimates that the user will take a train for travel on weekdays. When the analysis indicates that, on holidays, the user moves along a road to travel away from point A (the user's home), the information processing apparatus 10 estimates that the user will take a car for travel on holidays.

When the user enters his/her scheduled event using the terminal 20, the information processing apparatus 10 acquires the destination from the entered event and searches for a route toward the destination by assuming that the user's location estimated based on the start time of the event is a starting point of the route. For such routing, the information processing apparatus 10 may also assume that the user will take an estimated travel means in order to move.

When the travel route and the necessary time are determined as a result of the routing, the information processing apparatus 10 adds an event concerning the travel plan to the user's scheduler (such travel plan including, for example, the departure time, travel means and arrival time).

The information processing apparatus 10 is configured to estimate a starting point for routing from the history of location information and accordingly the information processing apparatus 10 is able to search for a route even when the scheduler has not received an input of a starting point. This leads to the reduction of steps that need to be performed by the user. Moreover, the information processing apparatus 10 searches for a route by taking the travel means routinely used by the user into account, so that a more appropriate route can be found.

Hardware Configuration

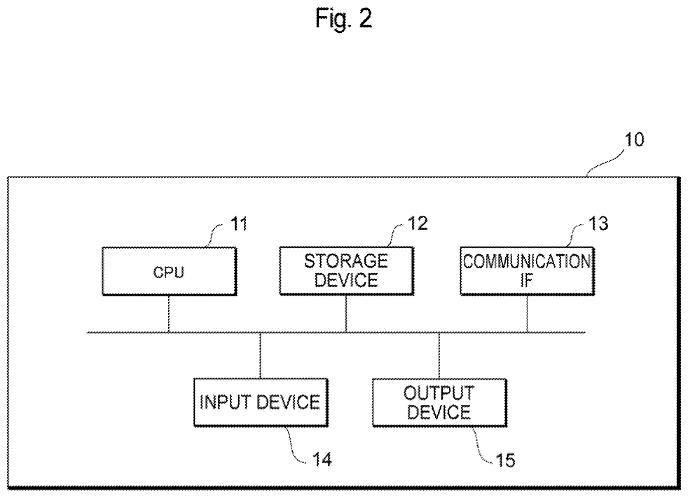

FIG. 2 illustrates an example of the hardware configuration of the information processing apparatus 10. The information processing apparatus 10 includes: a CPU (central processing unit) 11; a storage device 12, such as a memory, an HDD (hard disk drive), and/or an SSD (solid state drive); a communication interface (IF) 13 for wired or wireless communication; an input device 14 for receiving input operations; and an output device 15 for outputting information. The input device 14 may be, for example, a keyboard, a touch screen, a mouse and/or a microphone. The output device 15 may be, for example, a display and/or a loudspeaker.

Functional Block Configuration

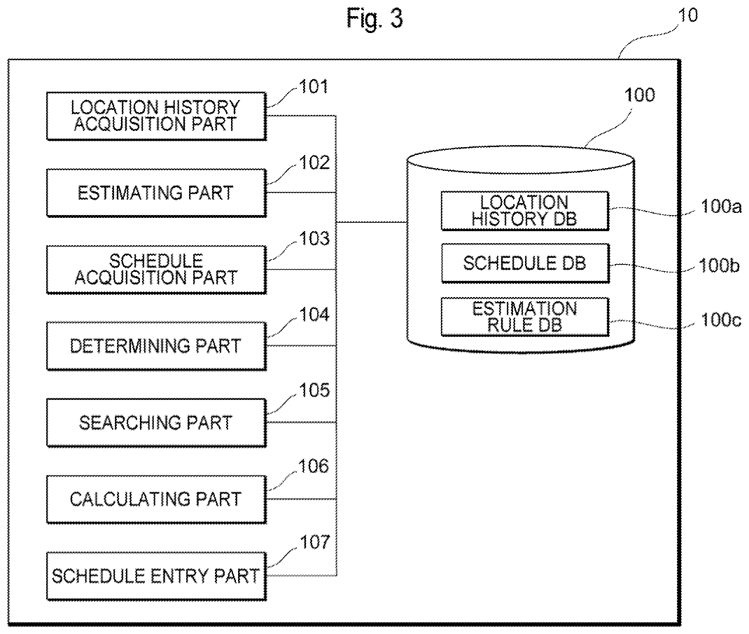

FIG. 3 illustrates an example of the functional block configuration of the information processing apparatus 10. The information processing apparatus 10 includes a storage part 100, a location history acquisition part 101, an estimating part 102, a schedule acquisition part 103, a determining part 104, a searching part 105, a calculating part 106 and a schedule entry part 107. The storage part 100 can be implemented by using the storage device 12 provided in the information processing apparatus 10. The location history acquisition part 101, the estimating part 102, the schedule acquisition part 103, the determining part 104, the searching part 105, the calculating part 106 and the schedule entry part 107 can be implemented by the CPU 11 of the information processing apparatus 10 executing programs stored on the storage device 12. Such programs may be stored on a storage medium. A storage medium storing the programs may be a non-transitory computer-readable medium. The non-transitory storage medium is not particularly limited and may be, for example, a USB memory or a CD-ROM.

The storage part 100 stores: a location history database (DB) 100a that stores the history of location information of each user (or of a terminal 20 of each user); a schedule database (DB) 100b that stores each user's scheduled events; and an estimation rule database (DB) 100c that stores estimation rules, each rule representing a method based on which the information processing apparatus 10 estimates each user's location and travel means.

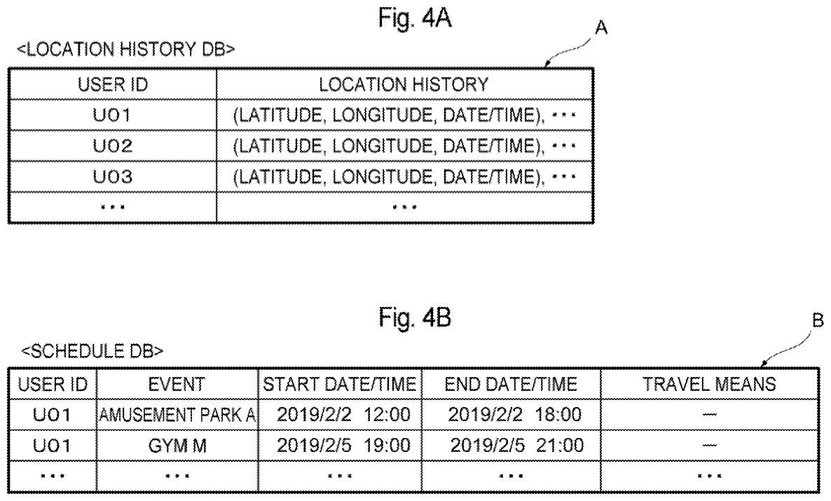

FIG. 4A shows an example of the location history DB 100a. The “User ID” field stores an identifier for uniquely identifying a user. The “Location History” field stores, for example, a plurality of pieces of location information indicating a point at which the terminal 20 was located, such information including the latitude and longitude of the point and the date and time when the terminal 20 was located at that point. By referring to the location history, it is possible to understand a path along which the terminal 20 previously moved.

FIG. 4B shows an example of the schedule DB 100b. The “User ID” field stores a user ID indicating the user who has a particular scheduled event. The “Event” field stores the content of an event input by the user upon entry of the event into the schedule. Here, the present embodiment is based on the assumption that each user inputs the destination of an event as the content of the event. The “Start Date/Time” field stores the date and time when the event is scheduled to start (in other words, the date and time by which the user needs to arrive at the destination). The “End Date/Time” field stores the date and time when the event is scheduled to end. The “Travel Means” field stores a travel means which is to be taken on the travel route determined as the result of routing by the information processing apparatus 10. When the user explicitly specifies the travel means at the time of entry of the event, the “Travel Means” field may store such travel means specified by the user.

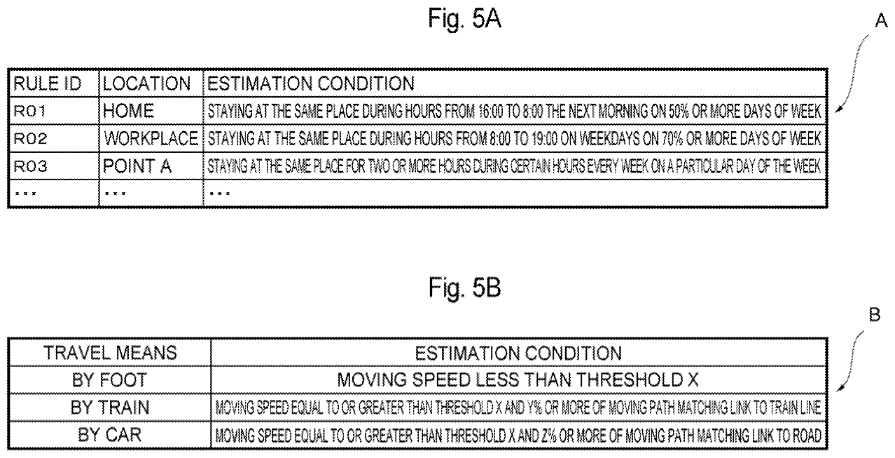

FIGS. 5A and 5B show examples of the estimation rule DB 100c. The estimation rule database will be described later.

The location history acquisition part 101 has the function of acquiring the history of location information of the user's terminal 20. The location history acquisition part 101 may acquire the history of the user's location information from the location history DB 100a stored on the storage part 100, or by accessing an external server that collects the location information of the terminal 20. In the latter case, the storage part 100 may include no location history DB 100a.

The estimating part 102 has the function of estimating the user's location for each particular time period in a day based on the history of location information acquired by the location history acquisition part 101. The estimating part 102 may further estimate the user's travel means for each particular time period in a day based on the history of location information acquired by the location history acquisition part 101.

The schedule acquisition part 103 has the function of acquiring, from the schedule DB 100b, a scheduled event of the user with a specified destination and start time of the event. The schedule acquisition part 103 may be configured not to acquire an event if either a destination or a start time is unspecified for the event (such event including, for example, an event not involving travel). In this embodiment, the “start time” is not limited to a particular clock time. The start time may also refer to a date and/or a day of the week.

The determining part 104 has the function of determining the starting point of the user by referring to the user's location for each particular time period in a day estimated by the estimating part 102, as well as the start time entered for the user's scheduled event. The determining part 104 may further determine the travel means applicable to the user's scheduled event by referring to the user's travel means for each particular time period in a day estimated by the estimation unit 102, as well as the start time entered for the user's scheduled event.

The searching part 105 has the function of searching for a travel route for traveling from the starting point determined by the determining part 104 to the destination specified for the scheduled event (such travel route may be, for example, a route on which the user walks and then takes a train or bus, etc., or a route on which the user drives a car) together with the necessary time for the route. The searching part 105 may be configured to perform such routing in a manner of searching for a travel route that uses the travel means determined by the determining part 104.

Here, the searching part 105 may be configured to access a server providing a routing function (e.g., a server providing a routing application programming interface (API)) that can communicate with the information processing apparatus 10 and to input the starting point and destination into the server so as to obtain a travel route and necessary time from the server. Alternatively, the storage part 100 may store map data so that the searching part 105 itself searches for a travel route and necessary time by using such map data.

The calculating part 106 has the function of calculating the departure time to travel to the destination, based on the necessary time obtained in the routing by the searching part 105. For example, if the start time of the event specified by the user is 9:00 a.m. and the necessary time is one hour, the calculating part 106 calculates the departure time to be 8:00 a.m., one hour before 9:00 a.m.

The schedule entry part 107 has the function of entering (or adding) a travel event into the user's schedule DB 100b, such travel event including the departure time calculated by the calculating part 106. The schedule entry part 107 may further enter into the schedule DB 100b, as part of the travel event, a travel means to be employed for the route obtained by the searching part 105.

Processing Steps

Next, various steps of the processing performed by the information processing apparatus 10 will be described in detail.

Estimation of Locations

The estimating part 102 estimates user's locations for each particular time period in a day, by referring to the location information history of the user's terminal 20 acquired by the location history acquisition part 101. A method for estimating user's locations based on predefined estimation rules (Estimation Method 1) and a method for estimating user's locations by using a pre-trained model which is capable of estimating user's locations and outputting the estimated locations (Estimation Method 2) will now be described in the following.

Estimation Method 1

The estimating part 102 estimates user's locations for each particular time period in a day by examining whether the history of location information includes location information that satisfies an estimation rule (a location estimation rule) defining the estimation conditions for estimating that the user is staying at a particular place at a particular time period in a day.

FIG. 5A shows examples of the estimation rule for estimating locations. In FIG. 5A, a record (in a row) defines one estimation rule. The “Rule ID” field in FIG. 5A contains an identifier for uniquely identifying each estimation rule in the information processing apparatus 10. The “Location” and “Estimation Condition” fields define a rule for estimating locations.

An estimation rule RO1 indicates that if the history of the user's location information shows that, in one particular week (which may be the most recent week, or may be one week starting from the most recent Sunday (or Monday) to Saturday (or Sunday)), the user stayed at a particular location during certain hours from 16:00 until 8:00 (the next morning) in 50% or more of the week (in other words, the number of days on which the user stayed at a particular location during certain hours from 16:00 until 8:00 (the next morning) accounted for 50% or more of the week), the particular location is estimated as the user's home and the user is estimated to be staying at the location (i.e., the user's home) during the certain hours.

Suppose, for example, that a user stayed at point A on Monday from 20:00 until 7:00 the next morning, on Tuesday from 22:00 until 8:00 the next morning, on Wednesday from 20:00 until 7:00 the next morning, on Thursday from 23:00 until 7:00 the next morning, on Friday from 22:00 until 6:00 the next morning, on Saturday from 16:00 until 8:00 the next morning, and on Sunday from 16:00 until 7:00 the next morning. In this example, the user stayed at point A during a period from 16:00 to 20:00 two days a week, the same user stayed at point A during a period from 20:00 to 22:00 four days a week, the same user stayed at point A during a period from 22:00 to 23:00 six days a week, the same user stayed at point A during a period of from 23:00 to 6:00 the next day seven days a week, the same user stayed at point A during a period from 6:00 to 7:00 six days a week, and the same user stayed at point A during a period from 7:00 to 8:00 two days a week. Since 50% or more of a week corresponds to 3.5 days or more, the estimating part 102 in this example estimates that the user is staying at point A (which is the user's home) during a period of from 20:00 until 7:00 the next morning.

Another estimation rule R02 indicates that if the history of the user's location information shows that, in one particular week, the user stayed at a particular location during certain hours from 8:00 to 19:00 on weekdays in 70% or more of the week (in other words, the number of days on which the user stayed at a particular location during certain hours from 8:00 to 19:00 on weekdays accounted for 70% or more of the week), the particular location is estimated as being the user's workplace and the user is estimated to be staying at the workplace during the certain hours. For example, if point B satisfies the condition of the estimation rule R02, more specifically, if the number of days on which the user stayed at point B during hours from 9:00 to 17:00 on weekdays was 70% or more of a week (i.e., 4.9 days or more), the estimating part 102 estimates that the user is located at point B (which is the user's workplace) from 9:00 to 17:00 on weekdays.

Another estimation rule R03 indicates that if the history of the user's location information shows that the user stayed at a particular place (e.g., place C) during certain hours every week (for example, every week in the most recent month) on a particular day of the week for a period of two or more hours, the user is estimated to be staying at such particular place during the certain hours every week on the particular day of the week. In other words, when the user performs an act periodically, the estimating part 102 detects such periodic act by analyzing the history of the user's location information and estimates the user's location based on a place that the user travels to in the periodic act.

It should be noted here that the estimation rules in FIG. 5A are by way of example only and other different estimation rules may be used.

Estimation Method 2

The estimating part 102 may include a pre-trained model that has been trained using data of dates and times combined with location information that are contained in the history of location information, and may estimate user's locations by utilizing location information provided from the pre-trained model in response to inputting a scheduled start time of an event into the model.

Such pre-trained model may be, for example, a model that has been trained by learning, as training data, respective sets of location information and days of week and times of day contained in the history of location information, so that the model will output, upon receiving an input of a particular time of day and particular day of week, location information indicating the user's location at that particular time and day.

By using the above-described estimation methods, the estimating part 102 can estimate, for example, that the point where the user is located during night-time is the user's home, or that the point where the user is located during daytime four or more days a week is a place where the user commutes to work or school. The estimating part 102 can also find a place at which the user stays periodically, such as places where the user stays for shopping, to see a doctor, or to drop and pick someone up, so that such places are also included in the user's estimated locations. Moreover, the estimating part 102 may generate a plurality of rules for estimating the user's home, so as to be able to estimate two or more places as the user's home. For example, when a user lives apart from his/her family as a result of a job transfer, more specifically, when a user stays at home with his/her family on the weekend but stays alone at a place near his/her workplace during weekdays, the estimating part 102 may estimate both of the two places as the user's home.

It should be noted here that, in the case where a user's event includes an input of the user's location (i.e., a starting point for routing) explicitly set by the user, the estimating part 102 may skip the step of estimating the locations. In that case, the searching part 105 will perform routing by regarding the location explicitly set by the user as a starting point for routing.

Estimation of Travel Means

The estimating part 102 may estimate a user's travel means for each particular time period in a day, by referring to travel means estimation rules, each defining the conditions for estimating a particular travel means, and the user's pattern of travel, which information can be obtained from the history of location information, and determining what estimation conditions the user's travel pattern satisfies.

FIG. 5B shows examples of the estimation rule for estimating travel means. A record (in a row) in FIG. 5B corresponds to one estimation rule.

The “Travel Means” field indicates an estimated travel means and data in this field serves as an identifier for uniquely identifying an estimation rule in the information processing apparatus 10. The “Estimation Condition” field indicates conditions for estimating a travel means.

A “By-Foot” estimation rule indicates that, if tracking the history of a user's location information chronologically provides a record of movement between certain points at a moving speed less than a threshold X, the user is determined as having moved between the points by foot.

A “By-Train” estimation rule indicates that, if tracking the history of a user's location information chronologically provides a record of movement between two certain points at a moving speed equal to or greater than the threshold X, and if Y % or more of the path of such movement matches a link to a train line on the map data, the user is determined as having moved between the two points by train. Such “By-Train” estimation rule may also include a condition that the path of movement includes two or more points at which a train station exists.

A “By-Car” estimation rule indicates that, if tracking the history of a user's location information chronologically provides a record of movement between two certain points at a moving speed equal to or greater than the threshold X, and if Z % or more of the path of such movement matches a link to a road on the map data, the user is determined as having moved between the two points by car.

The estimating part 102 uses the above-described estimation rules so as to estimate a travel means for each particular time period in a day. For example, if the history of the user's location information is tracked and analyzed chronologically to find that a predetermined percentage (e.g., 80% or more) of the user's movement on weekdays is by foot and by train and that a predetermined percentage (e.g., 80% or more) of the user's movement on holidays is by car, the estimating part 102 may estimate the user as traveling by train and by foot during weekdays and traveling by car on holidays.

It should be noted that the estimation rules shown in FIG. 5B are by way of example only, and other estimation rules may be used.

Creation of Travel Plan

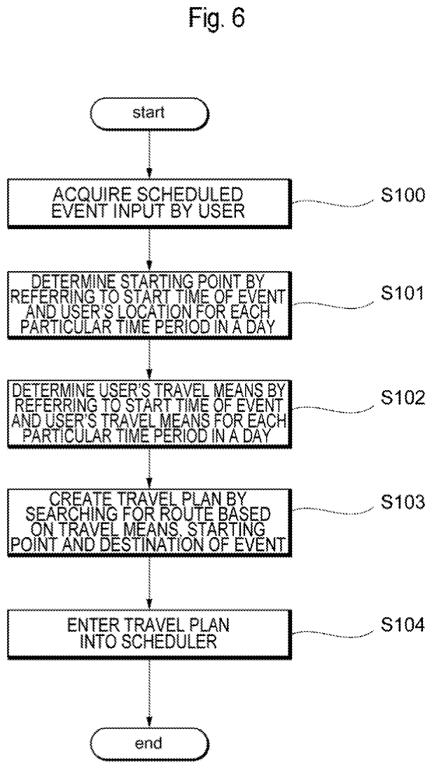

FIG. 6 is a flowchart showing an example of processing steps performed by the information processing apparatus 10. The processing steps performed by the information processing apparatus 10 to create a travel plan (travel program) for a scheduled event input by a user and add the plan to the user's schedule will be described with reference to FIG. 6.

At step S100, the schedule acquisition part 103 refers to the schedule database so as to acquire a scheduled event input by a user. More specifically, the schedule acquisition part 103 acquires, from among the scheduled events input by the user, an event having at least a specified start time and destination.

At step S101, the determining part 104 refers to the start time acquired at step S100, together with the user's locations estimated by the estimating part 102 for each particular time period in a day, so as to determine the user's location at the start time acquired at step S100.

At step 102, the determining part 104 again refers to the start time acquired at step S100, together with the user's travel means estimated by the estimating part 102 for each particular time period in a day, so as to determine the user's travel means at the start time acquired at step S100.

At step S103, the searching part 105 searches for a route for traveling from the location determined at step S101 (which is the starting point) toward the destination acquired at step S100 by using the travel means determined at step S102, as well as the necessary time for travel along the route. Furthermore, the calculating part 106 calculates the departure time at which the user needs to leave the starting point in order to arrive at the destination by the start time acquired at step S100, by subtracting the above-obtained necessary time from the start time.

At step S104, the schedule entry part 107 creates a new event (a travel event) indicating that the user will leave the user's location at the departure time calculated at step S103 and arrive at the destination by the start time acquired at step S100, and automatically enters the new travel event into the user's schedule DB 100b. Here, the schedule entry part 107 may also enter the route obtained at step S103 as part of the new event.

The information processing apparatus 10 may be configured to repeat the above-described steps S100 to S104 every time the user enters a new event into the schedule database.

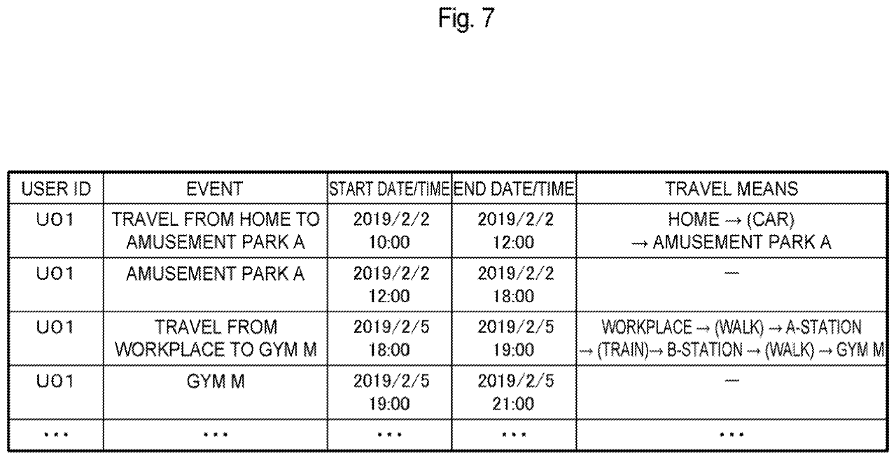

FIG. 7 shows specific examples of travel events that are newly entered by the information processing apparatus 10. Here, it is assumed that, for example, a user has entered a scheduled event to go to an amusement park A on Saturday, Feb. 2, 2019, from 12:00 to 18:00, and further assumed that such user is estimated to be staying at home and to use a car as a travel means on Saturdays.

The searching part 105 searches for a route for traveling by car from the user's home as the starting point toward the amusement park A as the destination. As a result, the searching part 105 finds that the necessary time is, for example, two hours. Here, if the travel means is by car, the searching part 105 may also investigate highway tolls (if applicable) and/or the distance of travel, in addition to the travel route and the necessary time.

Subsequently, the calculating part 106 determines that the user should leave home at 10:00 based on the necessary time being two hours. Here, the calculating part 106 may also calculate the necessary cost of gas for the travel based on the obtained distance of travel and predetermined gas mileage and gas price information.

After that, the schedule entry part 107 enters into the schedule a new event of traveling from home to the amusement park A, starting at 10:00 on Saturday, Feb. 2, 2019 and ending at 12:00 on the same day. The schedule entry part 107 also enters, as the travel means for the event, information indicating that the user is going to travel by car from home to the amusement park A. Such information entered as the travel means may include data indicating a detailed route on the map.

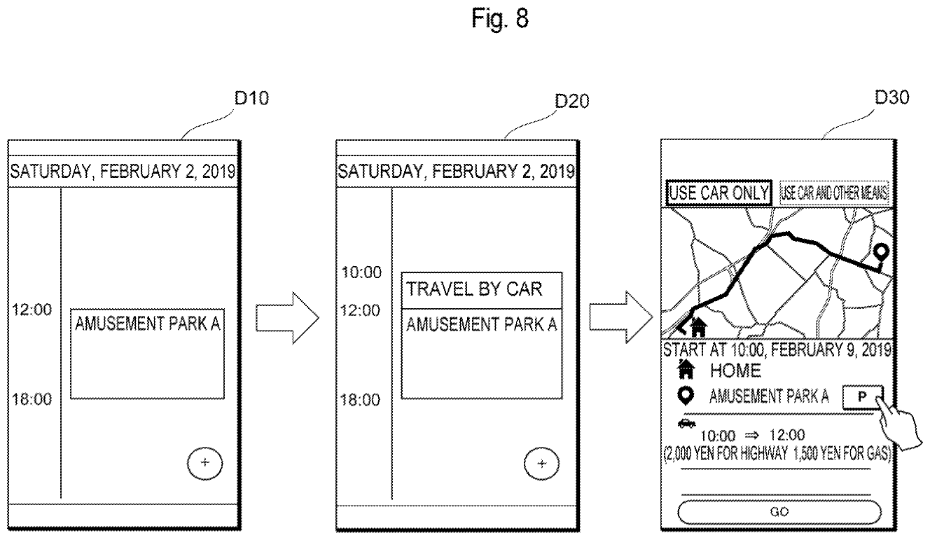

FIG. 8 shows examples of representations provided by the scheduler on the display of the terminal 20. When the user enters an event of going to the amusement park A as shown in display D10, a new event indicating that the user should travel from the user's location (the user's home in this example) to the amusement park A is added to the scheduler as shown in display D20.

When the user taps the new event on display D20, a navigation display is developed as shown in display D30 so that the user can see the specific route of travel and the necessary cost on the map.

Referring back to FIG. 7, it is assumed that the user has entered another event to go to a gym M on Tuesday, Feb. 5, 2019, from 19:00 to 21:00, and further assumed that the user is estimated to be staying at the user's workplace at 19:00 on Tuesdays and is also estimated to take trains as a travel means on this day and at this time.

The searching part 105 searches for a route for traveling by train from the workplace as the starting point to the gym M as the destination. As a result, the searching part 105 finds, for example, a route of walking from the workplace to A-station, taking a train from A-station to B-station, and then walking from B-station to the gym M, with the necessary time for the travel being one hour. The calculating part 106 then determines that the user should leave the workplace at 18:00 based on the necessary time being one hour. After that, the schedule entry part 107 enters a new event of traveling from the workplace to the gym M, starting at 18:00 on Tuesday, Feb. 5, 2019 and ending at 19:00 on the same day. The schedule entry part 107 also enters, as the travel means for the event, information indicating that the user is going to walk from the workplace to A-station, take a train from A-station to B-station, and then walk from B-station to the gym M. Such information entered as the travel means may include data indicating a specific route on the map.

Additionally or alternatively to the above description of the present embodiment, the information processing apparatus 10 according to the present embodiment may be configured such that, if a newly entered travel event specifies a car as a travel means, such travel event is automatically transmitted to a vehicle having an autonomous driving mode (such vehicle is not limited to an automobile, and may include a two-wheel vehicle, a small mobility vehicle, and the like) or to a navigation system installed in the vehicle. This configuration can reduce the steps to be taken by the user when the user moves with a vehicle.

Conclusion

According to the present embodiment described above, user's locations and travel means are estimated in advance based on the history of the user's location information, and as a result, even when a scheduled event of the user does not have an input of a starting point, routing can be performed and an event of travel can be added to the schedule based on the routing. As a result, upon entry of an event into the schedule, the user does not need to take the time to input a starting point for the event. Moreover, since routing can be performed by taking the travel means usually taken by the user into account, a more appropriate route can be obtained.

According to the present embodiment, when the user enters an event into the schedule, an event of travel is automatically added to the schedule by taking the user's travel means into account. Accordingly, the user does not need to enter a travel means upon entry of an event into the schedule. Furthermore, the present embodiment can reduce the processes which need to be taken by the user even when multimodal routing involving multiple travel means, such as travel by foot and by train, is necessary.

The embodiments described above are merely for facilitating the understanding of the present invention and are not intended to allow the present invention to be interpreted in a limited manner. The flowcharts, sequences, respective components of the embodiments, and the arrangements, materials, conditions, shapes and sizes, etc., of such components are not limited to those described above, and may be modified as appropriate. Furthermore, components in different embodiments may be partially substituted with each other, or may be combined.

The present invention provides a technique for enabling the entry of a travel plan even when schedule data input by a user does not include a starting point.

What is claimed is:

1. An information processing apparatus comprising:
a location history acquisition part that acquires history of location information of a terminal used by a user;
an estimating part that estimates the user's location for each particular time period in a day based on the history of the location information;
a schedule acquisition part that acquires, from the user's schedule information, a scheduled event with a specified destination and start time of the event;
a determining part that determines a starting point of the user by referring to the specified start time of the scheduled event and the user's estimated location for each particular time period in a day;
a searching part that searches for a route to travel from the determined starting point to the specified destination of the scheduled event, as well as a necessary time for the route;
a calculating part that calculates a departure time for travel to the destination based on the necessary time obtained by the searching part; and
an entry part that enters a travel event including the departure time into the user's schedule information.

2. The information processing apparatus according to claim 1, wherein
the estimating part further estimates a travel means of the user for each particular time period in a day based on the history of the location information,
the determining part further determines a travel means for the scheduled event by referring to the specified start time of the scheduled event and the estimated travel means for each particular time period in a day, and,
upon searching for a route by the searching part, the searching part searches for a route that uses the travel means determined by the determining part.

3. The information processing apparatus according to claim 2, wherein the estimating part estimates the user's travel means for each particular time period in a day by: referring to travel means estimation rules that define estimation conditions for each travel means, and the user's pattern of travel obtained from the history of the location information; and determining which of the estimation conditions the user's travel pattern satisfies.

4. The information processing apparatus according to claim 1, wherein the estimating part estimates the user's location for each particular time period in a day by analyzing whether the history of the location information includes location information that satisfies a location estimation rule that defines estimation conditions for estimating that the user is staying at a particular place at a particular time period in a day.

5. The information processing apparatus according to claim 1, wherein the estimating part includes a pre-trained model that has been trained using data of dates and times combined with location information contained in the history of the location information, and wherein the estimating part obtains location information that is output from the pre-trained model in response to inputting the specified start time of the scheduled event into the pre-trained model and estimates the user's location based on the obtained location information.

6. An information processing method implemented by an information processing apparatus, the method comprising the steps of:
acquiring history of location information of a terminal used by a user;
estimating the user's location for each particular time period in a day based on the history of the location information;
acquiring, from the user's schedule information, a scheduled event with a specified destination and start time of the event;
determining a starting point of the user by referring to the specified start time of the scheduled event and the user's estimated location for each particular time period in a day;
searching for a route to travel from the determined starting point to the specified destination of the scheduled event, as well as a necessary time for the route;
calculating a departure time for travel to the destination based on the necessary time obtained in the searching step; and
entering a travel event including the departure time into the user's schedule information.

7. A non-transitory computer-readable storage medium storing a program for causing a computer to perform the steps of:
acquiring history of location information of a terminal used by a user;
estimating the user's location for each particular time period in a day based on the history of the location information;
acquiring, from the user's schedule information, a scheduled event with a specified destination and start time of the event;
determining a starting point of the user by referring to the specified start time of the scheduled event and the user's estimated location for each particular time period in a day;
searching for a route to travel from the determined starting point to the specified destination of the scheduled event, as well as a necessary time for the route;
calculating a departure time for travel to the destination based on the necessary time obtained in the searching step; and
entering a travel event including the departure time into the user's schedule information.
